(19) United States
(12) Patent Application Publication
(10) Pub. No.: US 2018/0167090 A1
(43) Pub. Date: Jun. 14, 2018

(54) SIGNAL COMMUNICATION DEVICE, SIGNAL PROCESSING SYSTEM, AND SIGNAL COMMUNICATION METHOD

(71) Applicant: Renesas Electronics Corporation, Tokyo (JP)

(72) Inventors: Koichi ISHIMI, Tokyo (JP); Yuichiro TANAKA, Tokyo (JP)

(21) Appl. No.: 15/796,812

(22) Filed: Oct. 29, 2017

(30) Foreign Application Priority Data
Dec. 14, 2016 (JP) 2016-242461

(51) Int. Cl. H04B 1/04; H02N 11/00

(52) U.S. Cl. CPC H04B 1/04; H04W 84/12; H02N 11/002

(57) ABSTRACT

It is possible to utilize a system with a long response time using electricity generated by each generator of each communication unit. Communication units 20 and 30 include generators 21 and 31 for generating electricity utilizing a predetermined action included in a series of actions, and wireless communication circuits 24 and 34 operated by electricity supplied from the generators, respectively. The generator 21 generates electricity utilizing a certain action included in the series of actions, and the wireless communication circuit 24 transmits a signal to an external service server 70 when the certain action is done and the generator 21 generates electricity. The generator 31 generates electricity utilizing another action which is performed later in the series of actions, the wireless communication circuit 34 transmits a signal to the external service server 70 when that action is done and the generator 31 generates electricity.

### CROSS-REFERENCE TO RELATED APPLICATIONS

This application is based upon and claims the benefit of priority from Japanese patent application No. 2016-242461, filed on Dec. 14, 2016, the disclosure of which is incorporated herein in its entirety by reference.

### BACKGROUND

The present disclosure relates to a signal communication device and a signal processing system, for example, a signal communication device and a signal processing system including a generator which generates electricity utilizing an action of a human or the like. Further, the present disclosure relates to a signal communication method for a signal communication device and a signal processing system of that kind.

Japanese Unexamined Patent Publication No. 2009-162009 discloses an electric locking/unlocking device. The electric locking/unlocking device disclosed in Japanese Unexamined Patent Publication No. 2009-162009 comprises a charging means within a door. In Japanese Unexamined Patent Publication No. 2009-162009, it is disclosed that electric power to serve as driving force for locking or unlocking is charged in the charging means by self-power generation. In Japanese Unexamined Patent Publication No. 2009-162009, the self-power generation is performed by converting operational driving force applied to a doorknob or opening/closing driving force of a door into electric power.

Japanese Unexamined Patent Publication No. 2013-124514 discloses a doorknob type generator. In Japanese Unexamined Patent Publication No. 2013-124514, a cylinder portion is provided inside of a door handle unit, and a magnet unit and a coil unit are provided in the cylinder portion. In the doorknob type generator, the magnet unit moves when the door handle unit is operated and an inclination of the cylinder portion becomes equal to or greater than a certain value. As the magnet unit moves, electromagnetic induction occurs between the magnet unit and the coil unit, whereby electric power is generated.

In Japanese Unexamined Patent Publication No. 2013-124514, it is disclosed that information indicating that the door handle is operated is transmitted to an external signal receiving unit or the like using electric power generated in association with an operation of the doorknob. Further, in Japanese Unexamined Patent Publication No. 2013-124514, by utilizing the information indicating that the door handle is operated, it is possible to control turning on or turning off a light disposed inside of the door, starting or stopping an air conditioning, operation of a monitoring camera, or the like, which will be required after opening or closing the door.

Japanese Unexamined Patent Publication No. 2011-190572 discloses a self-power-generation type personal authentication system. In Japanese Unexamined Patent Publication No. 2011-190572, rotational energy of a doorknob is transferred to a generator, and electric energy is stored in a capacitor provided in the self-power-generation type personal authentication system. In Japanese Unexamined Patent Publication No. 2011-190572, it is possible to make use of the personal authentication system for a long period of time, by generating energy required for operating the personal authentication system itself from rotation of an operation member such as a doorknob rotated by a user, and storing it.

### SUMMARY

Japanese Unexamined Patent Publication No. 2009-162009 indicates that it is not necessary to draw power supply lines at a door since charging is performed using electric power generated by self-power generation. However, in Japanese Unexamined Patent Publication No. 2009-162009, it is necessary to draw power supply lines on a door frame where the door is provided. Further, in Japanese Unexamined Patent Publication No. 2009-162009, even if a system in which charging is performed only by self-power generation is configured, due to self-discharging or the like, there is a risk of a malfunction when the system is not used for a long period of time.

Japanese Unexamined Patent Publication No. 2013-124514 indicates that, while employing a simple mechanism, it is possible to efficiently generate electric power by rotating a doorknob. However, even if electric power can be efficiently generated, electric power obtained from operation of a doorknob is low, and a time duration of power generation is short. Accordingly, when considering a case where a certain service is provided to a user by only self-power generation, there is a problem that a processing time and power consumption are largely restricted.

In Japanese Unexamined Patent Publication No. 2011-190572, as electric power generated at a doorknob is stored, resistance to nonuse for a long time increases. However, also in Japanese Unexamined Patent Publication No. 2011-190572, there is a possibility of a malfunction due to self-discharge. Further, in Japanese Unexamined Patent Publication No. 2011-190572, there is a problem that it is necessary for a user to rotate a doorknob to perform charging when it is impossible to operate the system.

Other problems of the related art and new features of the present disclosure will become apparent from the following descriptions of the specification and attached drawings.

According to an example aspect, a signal communication device comprises: a first communication unit including a generator that generates electricity utilizing a first action included in a series of actions, and a wireless communication unit that transmits a first signal to an external device when the first action is done and the generator generates electricity; and a second communication unit including a generator that generates electricity utilizing a second action which is performed after the first action in the series of actions, and a wireless communication unit that transmits a second signal to the external device when the second action is done and the generator generates electricity.

According to the above example aspect, it is possible to utilize a system with a long response time using electricity generated by each generator of each communication unit.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a signal processing system including a signal communication device according to a first embodiment.

FIG. 2 is a diagram showing an example of a door at which a communication unit is provided.

FIG. 3 is a diagram showing a cross section of a vicinity of a doorknob of a door.

FIG. 4 is a diagram showing an internal structure of a door closer.

FIG. 5 is a flow chart showing an operation procedure in a signal processing system.

FIG. 6 is a timing chart showing operation circumstances of each unit in a signal processing system.

FIG. 7 is a block diagram showing a signal processing system according to a second embodiment.

FIG. 8 is a block diagram showing a signal processing system according to a third embodiment.

FIG. 9 is a timing chart showing operation circumstances of each unit in a signal processing system according to the third embodiment.

FIG. 10 is a block diagram showing a signal processing system according to a modified example.

### DESCRIPTION OF EMBODIMENTS

Hereinafter, embodiments incorporating means for solving the above-described problem will be described in detail with reference to the drawings. For the clarification of the description, the following description and the drawings may be omitted or simplified as appropriate. Further, each element shown in the drawings as functional blocks that perform various processing can be formed of a CPU (Central Processing Unit), a memory, and other circuits in hardware and may be implemented by programs loaded in the memory in software. Those skilled in the art will therefore understand that these functional blocks may be implemented in various ways by only hardware, only software, or the combination thereof without any limitation. Throughout the drawings, the same components are denoted by the same reference symbols and overlapping descriptions will be omitted as appropriate.

The above program can be stored and provided to a computer using any type of non-transitory computer readable medium. Non-transitory computer readable medium include any type of tangible storage medium. Examples of non-transitory computer readable medium include magnetic storage medium (such as floppy disks, magnetic tapes, hard disk drives, etc.), optical magnetic storage medium (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable medium. Examples of transitory computer readable medium include electric signals, optical signals, and electromagnetic waves. Transitory computer readable medium can provide the program to a computer via a wired communication line (e.g. electric wires, and optical fibers) or a wireless communication line.

The present disclosure will be described by dividing it into a plurality of sections or embodiments whenever circumstances require it for convenience in the following embodiments. However, unless otherwise particularly specified, these sections or embodiments may not be irrelevant to one another. One section or embodiment may be related to modifications, applications, details, supplementary explanations, and the like of some or all of the other ones. When reference is made to the number of elements or the like (including the number of pieces, numerical values, quantity, range, etc.) in the following embodiments, the number thereof is not limited to a specific number and may be greater than or less than or equal to the specific number unless otherwise particularly specified and definitely limited to the specific number in principle.

Further, in the following embodiments, components (including operation steps, etc.) are not always essential unless otherwise particularly specified and considered to be definitely essential in principle. Similarly, when reference is made to the shapes, positional relations, or the like of the components or the like in the following embodiments, they will include ones, for example, substantially approximate or similar in their shapes or the like unless otherwise particularly specified and considered not to be definitely so in principle. This is similarly applied even to the above-described number or the like (including the number of pieces, numerical values, quantity, range, etc.).

### First Embodiment

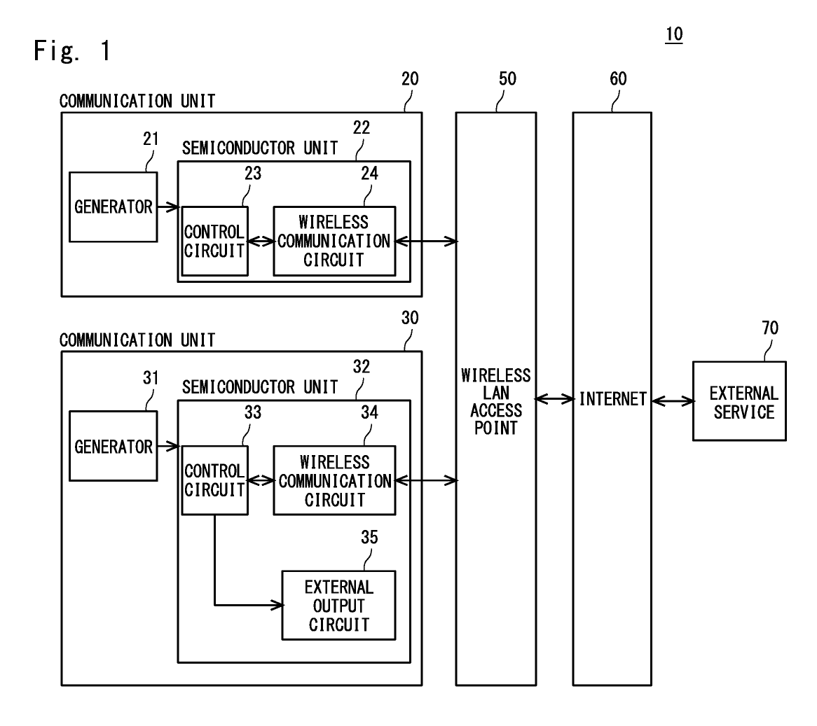

FIG. 1 shows a signal processing system including a signal communication device according to a first embodiment. A signal processing system 10 comprises a communication unit 20, a communication unit 30, a wireless LAN (Local Area Network) access point apparatus 50, and an external service server 70. The communication unit 20 and the communication unit 30 constitute a signal communication device in the signal processing system 10. In addition, the external service server 70 constitutes a signal processing device (an external device). The wireless LAN access point apparatus 50 and the external service server 70 are respectively connected to the internet 60. The wireless LAN access point apparatus 50 functions as a relay apparatus relaying communication between the communication units 20 and 30 and the external service server 70.

The communication unit 20 comprises a generator 21 and a semiconductor unit 22. The semiconductor unit 22 comprises a control circuit 23 and a wireless communication circuit (a wireless communication unit) 24. The communication unit 30 comprises a generator 31 and a semiconductor unit 32. The semiconductor unit 32 comprises a control circuit 33, a wireless communication circuit (a wireless communication unit) 34, and an external output circuit 35. The generator 21 and the generator 31 generate electricity utilizing a predetermined action included in a series of actions. The semiconductor unit 22 and the semiconductor unit 32 are operated by electricity supplied from the generator 21 and the generator 31, respectively. The communication unit 20 and the communication unit 30 are formed by known products or known production techniques.

Note that the generator 21 generates electricity utilizing a certain action included in the series of actions. On the other hand, the generator 31 generates electricity utilizing an action performed after the action which the generator 21 utilizes for generating electricity in the series of actions. Accordingly, in the communication unit 20 and the communication unit 30, timings of power generation are different from each other. Further, as the semiconductor unit 22 and the semiconductor unit 32 are respectively operated by electricity supplied from the generator 21 and the generator 31, operational timings of the semiconductor unit 22 and the semiconductor unit 32 are also different from each other.

The control circuit 23 included in the semiconductor unit 22 controls each part in the semiconductor unit 22. The wireless communication circuit 24 performs wireless communication with the wireless LAN access point apparatus 50. The control circuit 23 instructs the wireless communication circuit 24 to transmit a signal to the external service server 70, when the generator 21 generates electricity. Upon receiving this instruction, the wireless communication circuit 24 performs wireless communication with the wireless LAN access point apparatus 50 to transmit a signal to the external service server 70 through the internet 60. The wireless communication circuit 24 transmits, for example, a signal including identification information unique to the communication unit 20 to the external service server 70.

The control circuit 33 of the semiconductor unit 32 controls each part in the semiconductor unit 32. The wireless communication circuit 34 performs wireless communication with the wireless LAN access point apparatus 50. The control circuit 33 instructs the wireless communication circuit 34 to transmit a signal to the external service server 70, when the generator 31 generates electricity. Upon receiving this instruction, the wireless communication circuit 34 performs wireless communication with the wireless LAN access point apparatus 50 to transmit a signal to the external service server 70 through the internet 60. The wireless communication circuit 34 transmits, for example, a signal including identification information unique to the communication unit 30 to the external service server 70.

The external service server 70 respectively receives signals from the communication unit 20 and the communication unit 30 through the wireless LAN access point apparatus 50 and the internet 60. The external service server 70 initiates a certain process when it receives the signal from the communication unit 20. The external service server 70 waits to receive a signal from the communication unit 30, after performing that process.

The external server 70 performs a next process when it receives the signal from the communication unit 30. The process to be executed by the external service server 70 after it receives the signal from the communication unit 30 includes, for example, a process in which at least one of a signal indicating a response to the signal transmitted from the communication unit 20 and a signal indicating a process execution result of the above process is transmitted to the communication unit 30

The external service server 70 executes, for example, a process for providing a certain service when it receives the signal from the communication unit 20. After initiating the process, the external service server 70 suspends the process, for example, at a stage before transmitting at least one of a signal indicating a response to the signal received from the communication unit 20 and a signal indicating a process execution result of the process. The external service server 70 then waits to receive the signal from the communication unit 30. The external service server 70 resumes the process when it receives the signal from the communication unit 30, and then executes a process in which at least one of a signal indicating a response to the signal received and a signal indicating a process execution result is transmitted to the communication unit 30.

The control circuit 33 of the communication unit 30 receives, via the wireless communication circuit 34, at least one of a signal indicating a response to the signal transmitted by the communication unit 20 and a signal indicating a process execution result of the process which has been executed in response to the signal transmitted by the communication unit 20 from the external service server 70. The control circuit 33, for example, carries out a notification to a person (user) who has performed the series of actions according to the signal indicating the process execution result using the external output circuit 35. The external output circuit 35 includes an output device such as a LED (light Emitting Diode), buzzer, and the like, for example, and carries out the notification to the user using light or sound.

### [Example Disposition of the Communication Unit]

In the following description, a case in which the communication unit 20 and the communication unit 30 are disposed at a door is mainly considered. Further, actions in which a person opens and closes a door are mainly considered as a series of actions. Opening and closing a door includes an action in which a person rotates a doorknob or the like, an action in which the person opens a door, an action in which the person closes a door, and the like. The communication unit 20 and the communication unit 30 are disposed, for example, at different portions of the same door.

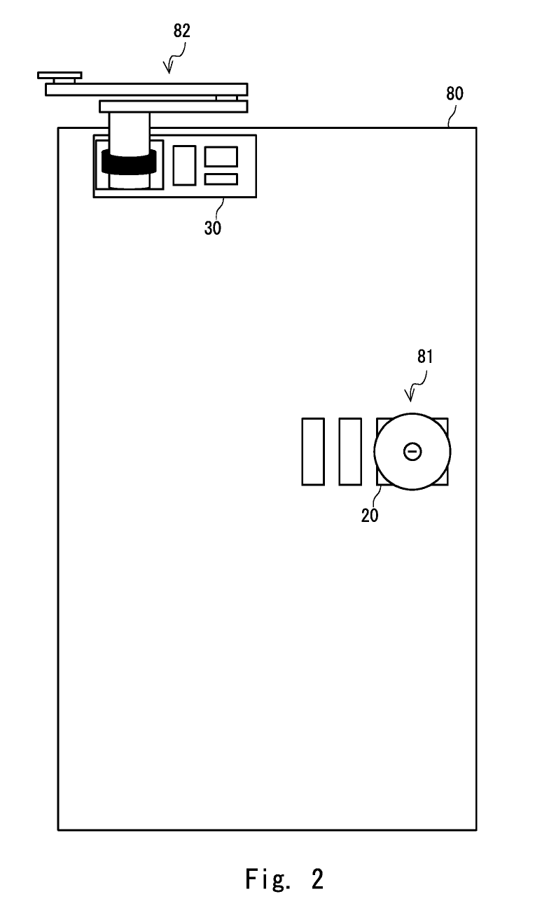

FIG. 2 shows an example of a door at which the communication units are disposed. In this example, the communication unit 20 is disposed corresponding to a doorknob 81 of a door 80. Further, the communication unit 30 is disposed corresponding to a door closer 82 for closing the door 80 that has been opened. The generator 21 (refer to FIG. 1) of the communication unit 20 generates electricity, for example, utilizing an action of a person and the like rotating a doorknob. On the other hand, the generator 31 of the communication unit 30 generates electricity, for example, utilizing an action of closing the door 80 in opening and closing the door 80. In general, the action of the door 80 closing has more momentum than the action for rotating the doorknob 81. In the present embodiment, it is assumed that the generated electric power of the generator 31 is greater than that of the generator 21.

### [Communication Unit 20]

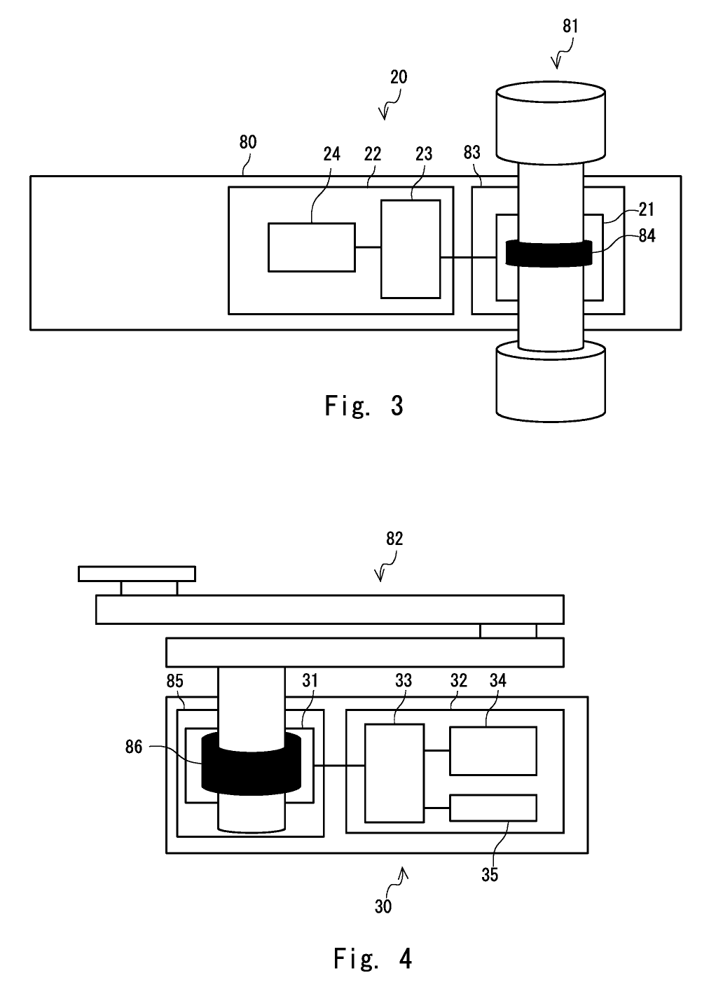

FIG. 3 shows a cross section of the vicinity of the doorknob 81 of the door 80. The communication unit 20 is disposed, for example, inside of the door 80 in the vicinity of the doorknob 81, or, on the surface of the door 80 in the vicinity of the doorknob 81. The communication unit 20 comprises, as a mechanical unit 83, the generator 21 and a one way clutch mechanism 84. The rotating shaft of the generator 21 rotates when the doorknob 81 rotates, and the generator 21 generates electricity utilizing rotating force applied to the doorknob 81. The electric power generated by the generator 21 is supplied to the semiconductor unit 22, whereby the control circuit 23 and the wireless communication circuit 24 become operable. It is assumed that the semiconductor unit 22 has no power sources other than the generator 21. In other words, it is assumed that electric power necessary for the semiconductor unit 22 can be covered by the electric power generated by the generator 21.

The one way clutch mechanism 84 transfers the rotating force to the generator 21 only when the doorknob 81 rotates in a certain direction from an initial position. The one way clutch mechanism 84 does not transfer the rotating force to the generator 21 when the doorknob 81 rotates in the direction opposite to the certain direction. The one way clutch mechanism 84 transfer the rotating force, for example, when a person rotates the doorknob 81 in a rotating direction to open the door 80. The one way clutch mechanism 84 does not transfer the rotating force to the generator 21, for example, when the person releases a hand from the doorknob 81 and the doorknob 81 rotates in a direction in which the initial position is returned to. By using the one way clutch mechanism 84 of this kind, the action of returning the doorknob 81 to the initial position is not hindered when the person releases his/her hand from the doorknob 81 after the person rotates the doorknob 81 to open the door 80.

### [Communication Unit 30]

FIG. 4 shows an internal structure of a door closer 82. The door closer 82 is a unit which generates force to rotate a door in a direction to close a door with respect to an opened door. The communication unit 30 is, for example, disposed in the door closer 82. The communication unit 30 comprises, as a mechanical unit 85, the generator 31 and a one way clutch mechanism 86. The rotating shaft of the generator 31 rotates when a rotating shaft in the door closer 82 rotates, and the generator 31 generates electricity utilizing rotating force applied to the rotating shaft of the door closer 82. The electric power generated by the generator 31 is supplied to the semiconductor unit 32, whereby the control circuit 33, the wireless communication circuit 34, and the external output circuit 35 become operable. It is assumed that the semiconductor unit 32 has no power sources other than the generator 31. In other words, it is assumed that electric power necessary for the semiconductor unit 32 can be covered by the electric power generated by the generator 31.

The one way clutch mechanism 86 transfers rotating force to the generator 31 only when the rotating shaft of the door closer 82 rotates in a certain direction. The one way clutch mechanism 86 does not transfer rotating force to the generator 31 when the rotating shaft of the door closer 82 rotates in the direction opposite to the certain direction. The one way clutch mechanism 86 transfers rotating force to the generator 31, for example, when the rotating shaft of the door closer 82 rotates in a direction in which the door is closed. The one way clutch mechanism 86, for example, does not transfer rotating force to the generator 31 when the rotating shaft of the door closer 82 rotates in a direction in which the door is opened. By using the one way clutch mechanism 86 of this kind, the action of a person opening the door is not hindered.

### [Operation Procedure]

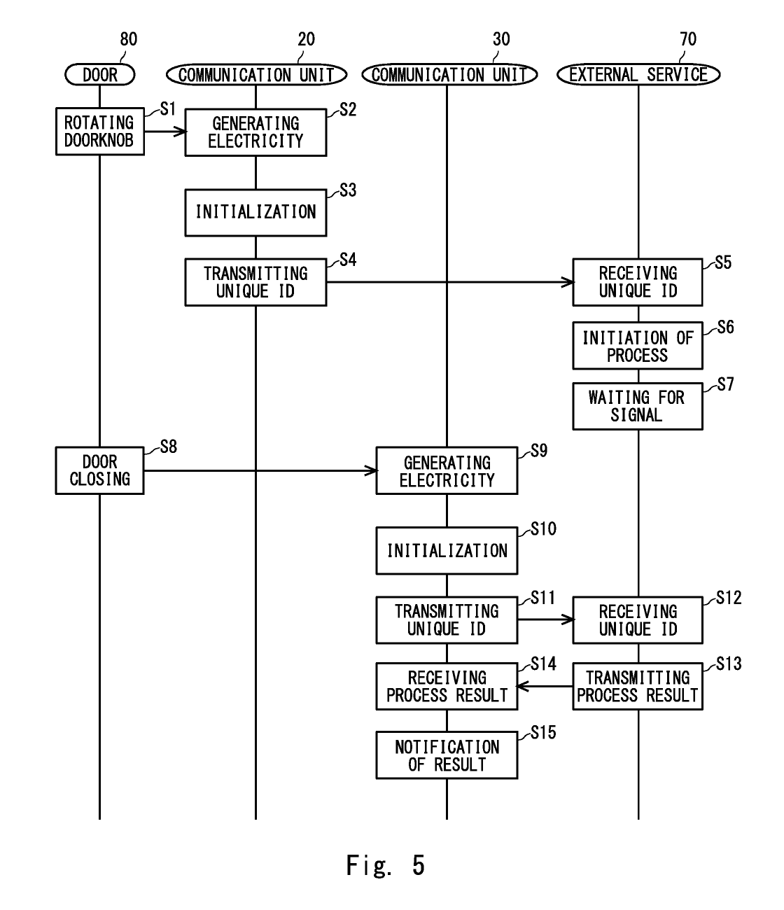

FIG. 5 shows operation procedure in the signal processing system. For example, the door 80 are located at a doorway to/from a particular place. When a user holds and rotates the doorknob 81 (refer to FIG. 2) of the door 80 (Step S1), the rotating shaft of the generator 21 that has been connected to the doorknob 81 via the one way clutch mechanism 84 (refer to FIG. 3) rotates and thereby electricity is generated (Step S2). When the generator 21 generates electricity, electric power is supplied to the semiconductor unit 22 of the communication unit 20. When the user releases his/her hand from the doorknob 81, the doorknob 81 reversely rotates and returns to the initial position. A known mechanism, which is adopted in commercially available doorknobs, is used for a mechanism for returning the doorknob 81 to the initial position. By the effect of the one way clutch mechanism 84, the generator 21 does not produce resistance force against the action of returning the doorknob 81 to the initial position.

In the communication unit 20, when electric power is supplied to the semiconductor unit 22 from the generator 21, the control circuit 23 performs initialization (Step S3). In this initialization, the control circuit 23 activates the wireless communication circuit 24, and causes wireless communication between the wireless communication circuit 24 and the wireless LAN access point apparatus 50 (refer to FIG. 1) to be initiated. After the initialization, the wireless communication circuit 24 transmits a signal including a unique ID (Identifier) to the external service server 70 through the wireless LAN access point apparatus 50 and the internet 60 (Step S4).

The external service server 70 receives the signal including the ID from the communication unit 20 (Step S5), and then initiates a process according to the ID received (Step S6). The external service server 70 performs the process up to a predetermined state, and suspends the process, for example, at a stage before a process execution result is transmitted. The external service server 70 enters a state for waiting for transmission of the process execution result, and waits until a signal is transmitted from the communication unit 30 (Step S7).

After the user rotates the doorknob 81 to open the door 80, the door closer 82 (refer to FIG. 4) performs rotary motion, thereby the door 80 moves in a direction of closing (Step S8) when the user releases his/her hand from the door 80. At that time, in the door closer 82, the rotating shaft of the generator 31 rotates as it connects to the rotating shaft of the door closer 82 via the one way clutch mechanism 86 in the door closer 82, whereby electricity is generated (Step S9). When the generator 31 generates electricity, electric power is supplied to the semiconductor unit 32 of the communication unit 30. By the effect of the one way clutch mechanism 86, the generator 31 does not produce resistance force against the action of opening the door by the user.

In the communication unit 30, when electric power is supplied to semiconductor unit 32 from the generator 31, the control circuit 33 performs initialization (Step S10). In this initialization, the control circuit 33 activates the wireless communication circuit 34, and causes wireless communication between the wireless communication circuit 34 and the wireless LAN access point apparatus 50 to be initiated. The wireless communication circuit 34 transmits a signal including a unique ID to the external service server 70 through the wireless LAN access point apparatus 50 and the internet (Step S11).

The external service server 70 receives the signal including the ID from the communication unit 30 (Step S12). In the external service server 70, IDs of the two communication units disposed at the same door are stored in association with each other. In the external service server 70, it is confirmed that the ID included in the signal received at Step S12 is an ID of a communication unit which is disposed at the same door as the one that the communication unit identified by the ID included in the signal received at Step S5 is disposed at. The external service server 70 terminates the waiting sate of Step S7, and transmits, to the wireless communication circuit 34, a signal indicating the process execution result, transmission of which had been waited for (Step S13).

In the communication unit 30, the wireless communication circuit 34 receives the signal indicating the process execution result (Step S14). The control circuit 33 performs a process according to the process execution result received by the wireless communication circuit 34, and notifies a user using the external output circuit 35 (Step S15).

### [Operation Example]

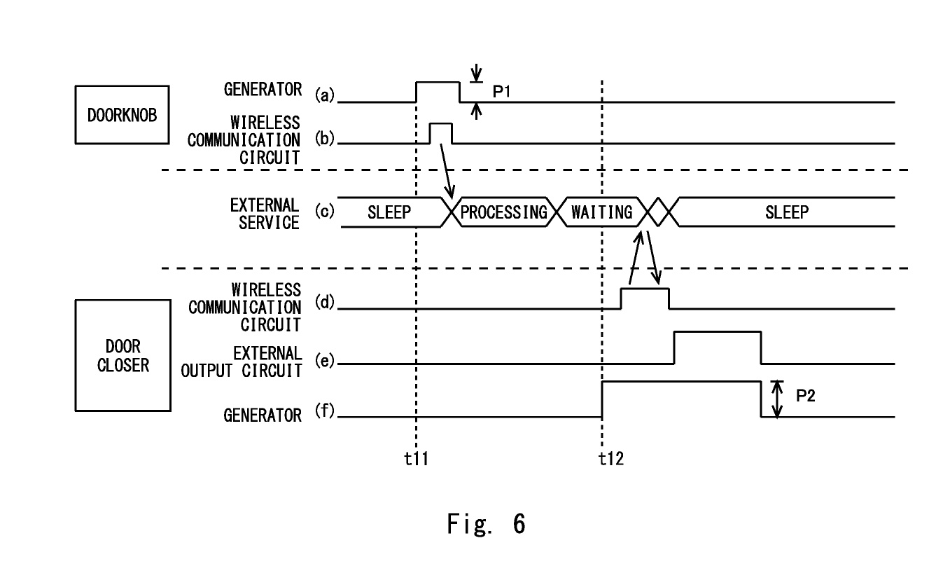

FIG. 6 is a timing chart showing operation circumstances of each unit in a signal processing system 10. It is assumed that the external service server 70 is in a sleep state before it receives a signal from the communication unit 20. At time tll, when a user rotates a doorknob, the generator 21 of the communication unit 20 disposed in the doorknob generates electricity (refer to (a) in FIG. 6). The generated power (peak value) of the generator 21 at that time is denoted by Pl. The wireless communication circuit 24 receives a power supply from the generator 21, and transmits a signal including a unique ID to the external service server 70 (refer to (b) in FIG. 6).

When the external service server 70 receives the signal from the wireless communication circuit 24 of the communication unit 20, it initiates a process (refer to (c) in FIG. 6). At that time, since the generator 21 generates electricity utilizing a rotary motion of the doorknob and a power generation period is short, the power supply to the wireless communication circuit 24 has been stopped (refer to (a) and (b) in FIG. 6). After initiating the process, the external service server 70 suspends the process, for example, at a stage before a signal indicating a process execution result of the process is transmitted, and waits until a signal is transmitted from the wireless communication circuit 34 of the communication unit 30.

At time t12, when the door starts to close, the generator 31 of the communication unit 30 disposed in a door closer generates electricity (refer to (f) in FIG. 6). The generated power (peak value) of the generator 31 at that time is denoted by P2. The generated power P2 of the generator 31 is greater than the generated power P1 of the generator 21. In addition, normally, since time required for the door to close is longer than time required for the doorknob to rotate, a power generation period of generator 31 is longer than a power generation period of the generator 21. As a result, the generator 31 can supply electric power to semiconductor unit 32 for a long period of time, compared to a period of time for which the generator 21 supplies electric power to the semiconductor unit 22.

The wireless communication circuit 34 of the communication unit 30 receives a power supply from the generator 31, and transmits a signal including a unique ID to the external service server 70 (refer to (d) in FIG. 6). When the external service server 70 receives the signal from the wireless communication circuit 34, it terminates the waiting state and transmits a signal indicating a process execution result to the wireless communication circuit 34 (refer to (c) and (d) in FIG. 6). After that, the control circuit 33 notifies the user about the process execution result via the external output circuit 35 (refer to (e) in FIG. 6). For example, the external output circuit 35 continues to notify the user until the power supply supplied from the generator 31 is stopped.

### [Summary]

In the present embodiment, each communication unit comprises a generator. Each communication unit activates a wireless communication circuit using electricity supplied by its own generator, and transmits a signal to an external service server. In each communication unit, the generator generates electricity utilizing a predetermined action included in a series of actions, respectively. In the present embodiment, in the communication unit 20, the generator 21 generates electricity utilizing a certain action included in the series of actions. It is possible to transmit a signal to the external service server 70 in response to the action being performed, as a trigger. Further, after that, in the communication unit 30, the generator 31 generates electricity utilizing another action included in the series of actions. In this way, it is possible to transmit a signal to the external service server 70 in response to another action being performed later, as a trigger.

Note that the actions of a human are composed of a combination of various actions, and there is a certain order in execution of each action in a series of actions. In the present embodiment, in particular, actions moving between spaces separated by a door are focused on. In these actions, in order to open a door, it is necessary to rotate a doorknob before opening the door, and thus it is considered that an action of opening a door is never performed before an action of rotating a doorknob. Accordingly, rotation of a door closer occurs after rotation of the doorknob. By converting energy generated in each action into electric power with respect to actions the execution order of which is determined as described above, it is possible to operate a system in an appropriate order in accordance with the actions.

In the present embodiment, in particular, the generator 21 of the communication unit 20 generates electricity utilizing rotary motion of a doorknob and the generator 31 of the communication unit 30 generates electricity utilizing an action of a door closing. In a series of actions in which, for example, a user opens a door or the like to enter a room, as rotation of a doorknob is performed first and then a door is opened and closed afterward, out of the two communication units, the communication unit 20 is activated first and thereafter the communication unit 30 is activated. In this way, by shifting power generation timings of the generators between the two communication units, it is possible to shift timings of signal transmission to the external service server 70 between the communication unit 20 and the communication unit 30.

By shifting timings of signal transmission as described above, the communication unit 30 which operates later than the communication unit 20 can receive, for example, the process execution result of a process which is initiated in the external service server 70 by the communication unit 20 transmitting a signal, as shown in FIG. 6. In this case, the communication unit 30 can receive the process execution result even if a power supply has been stopped in the communication unit 20 before the process execution result is obtained in the external service server 70.

Tentatively, a case in which only one of the communication unit 20 and the communication unit 30, for example only the communication unit 30 is used and the external service server 70 initiates a process after the communication unit 30 transmits a signal is considered. In this case, although the power generation period of generator 31 is longer than the power generation period of the generator 21, it is not long enough with respect to a process execution period in the external service server 70. Accordingly, it is considered that there may be a case where the power generation period ends before the process execution result is obtained in the external service server 70. In the present embodiment, by using a plurality of communication unit and utilizing a time difference of actions in the series of actions utilized for generating electricity between the communication units, it is possible to receive the process execution result even in cases where a period of time required for obtaining the process execution result from the initiation of the process is longer that the power generation period of each generator. In other words, in the present embodiment, it is possible to utilize an external service in which results cannot be obtained within the power generation period of each generator.

In the present embodiment, the generated electric power of the generator 21 is lesser than that of the generator 31. As the communication unit 20, which operates earlier among the communication unit 20 and the communication unit 30, is only required to transmit a signal to the external service server 70, power consumption may not be so high, and the operation period may be short. In contrast, since the communication unit 30 which operates later than the communication unit 20 carries out a notification and the like using the external output circuit 35, power consumption of the communication unit 30 is higher than that of the communication unit 20. In addition, it is required that the communication unit 30 operates continuously for a certain period of time. In the present embodiment, a process consuming lots of electric power, for example a process of calculation, external output controlling, or the like is executed in the communication unit 30 having high generation power. In this way, in the present embodiment, a generator, generated electric power of which is suitable for the communication unit, is disposed in each communication unit.

In the present embodiment, a semiconductor unit of each communication unit only utilizes electric power generated by the generator of each communication unit, namely it only utilizes electric power generated in a period of time in which an associated action is performed. In the present embodiment, as the generator generates electricity having an amount and a duration required for the operation of the semiconductor unit, it is not necessary to provide a power storage system. By operating the semiconductor unit only by self-generated electric power, it is possible to properly operate the semiconductor unit without charging electricity even in a case where the system is not used for a long period of time. Accordingly, it is possible to preclude negative effects due to self-discharge when the system is not used for a long period of time.

### Second Embodiment

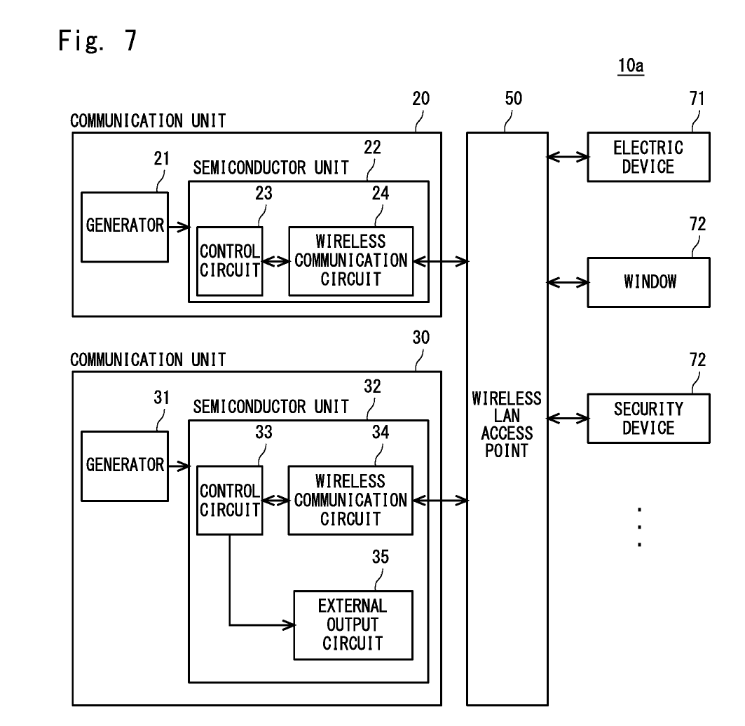

Next, a second embodiment is described. FIG. 7 shows a signal processing system according to the second embodiment. A signal processing system 10a according to the present embodiment is different from the signal processing unit 10 according to the first embodiment shown in FIG. 1 in that a transmission destination of signals of the communication unit 20 and the communication unit 30 is changed to a device connected to the wireless LAN access point apparatus 50. In the present embodiment, signals are transmitted to an electric household appliance or the like through the wireless LAN access point apparatus 50 located, for example in a home.

In the present embodiment, for example, devices (external device or signal processing device) such as an electric device (an electric household appliance) 71, a window (a locking device) 72, a security device 73, and the like are connected to the wireless LAN access point apparatus 50. Communication between these devices and the wireless LAN access point apparatus 50 may be wireless communication or may be wired communication. Note that devices connected to the wireless LAN access point apparatus 50 are not limited to these devices. Other devices which are to be moved to prescribed states when user going out may be connected to the wireless LAN access point apparatus 50.

### [Explanation of an Operation]

For example, when a person is leaving a room via a door, as the doorknob 81 (refer to FIG. 3) is rotated and electricity is generated in the communication unit 20 by the generator 21, the wireless communication circuit 24 transmits a signal including the ID of the communication unit 20 to the devices such as the electric device 71, the window 72, the security device 73, and the like, via the wireless LAN access point apparatus 50. The electric device 71 changes its operation mode to a low power consumption mode, or carries out a shutdown of the device, when the signal including the ID of the communication unit 20 is received. The window 72 causes a motor or the like to operate for transferring the window key to a locked state, when the signal including the ID of the communication unit 20 is received. The security device 73 activates security functions, when the signal including the ID of the communication unit 20 is received.

Next, when the door closer 82 (refer to FIG. 4) operates, electricity is generated in the communication unit 30 by the generator 31. When the generator 31 generates electricity, the wireless communication circuit 34 transmits, via the wireless LAN access point apparatus 50, a signal including the ID of the communication unit 30 to devices to which the wireless communication circuit 24 of the communication unit 20 has transmitted the signal when the doorknob is rotated. That is, the wireless communication circuit 34 transmits a signal including the ID of the communication unit 30 to the devices such as the electric device 71, the window 72, the security device 73, and the like, via the wireless LAN access point apparatus 50.

Upon receiving the signal including the ID of the communication unit 30, the devices such as the electric device 71, the window 72, and the security device 73 transmit, to the wireless communication circuit 34, a signal indicating whether each device has transferred to an expected state or not. The control circuit 33 controls the external output circuit 35 based on the signal, received by the wireless communication circuit 34, indicating whether each device has transferred to an expected state or not. The control circuit 33 notifies a user about the confirmation result indicating whether each device has transferred to an expected state or not, using the external output circuit 35.

### [Summary]

The signal processing system 10a according to the present embodiment can be used, for example, as a service system in a private network, each communication unit of which accesses devices or the like in a house via the wireless LAN access point apparatus 50. In the present embodiment, since connecting to the Internet is not required unlike in the first embodiment, it is possible to incorporate devices which are only allowed to connect to a local network into the system.

### Third Embodiment

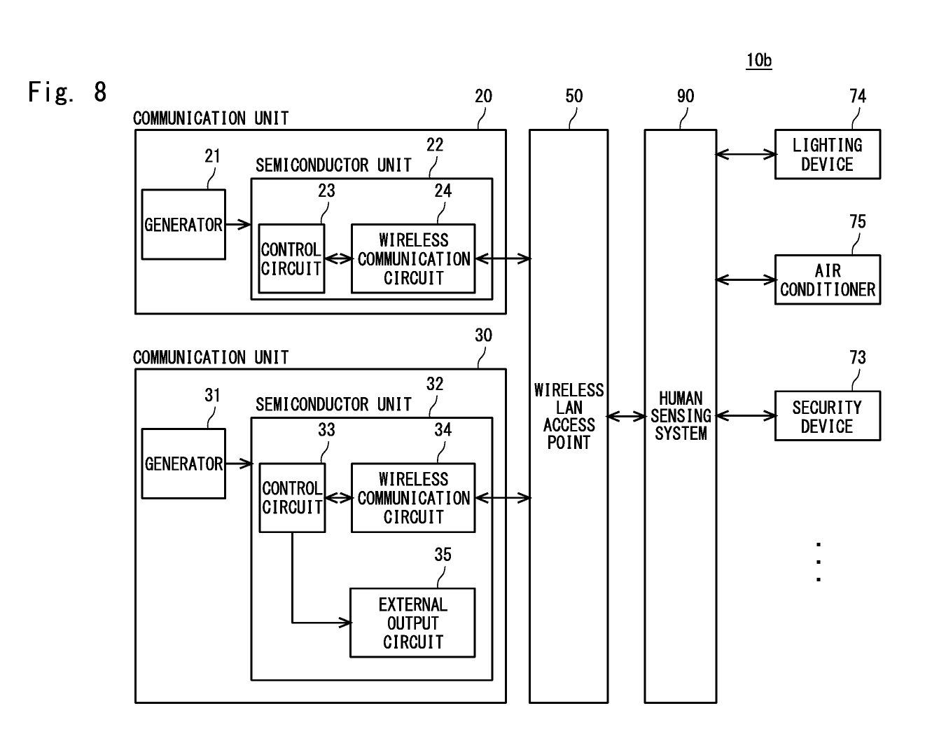

Further, a third embodiment is explained. FIG. 8 shows a signal processing system according to the third embodiment. A signal processing system 10b according to the present embodiment is different from the signal processing system 10 according to the first embodiment shown in FIG. 1 in that a transmission destination of signals of the communication unit 20 and the communication unit 30 is changed to a human sensing system 90 connected to the wireless LAN access point apparatus 50. In the present embodiment, the human sensing system 90 constitutes an external device or a signal processing device.

To the human sensing system 90, devices such as the security device 73, a lighting device 74, an air conditioner 75 and the like are connected. The human sensing system 90 comprises a sensor, for example, for detecting a human in a predetermined place or the like. The human sensing system 90 controls the devices such as the security device 73, the lighting device 74, the air conditioner 75, and the like based on the result of the human detection. It is assumed that the human sensing system 90 requires a relatively long time to proceed from the initiation of the startup to a state capable of detecting a human.

### [Explanation of Operations]

For example, when a person moves through a door, as the doorknob 81 (refer to FIG. 3) is rotated, and electricity is generated in the communication unit 20 by the generator 21, the wireless communication circuit 24 transmits a signal including the ID of the communication unit 20 to the human sensing system 90 via the wireless LAN access point apparatus 50. The human sensing system 90 initiates its startup when the signal including the ID of the communication unit 20 is received.

Next, when the door closer 82 (refer to FIG. 4) operates, electricity is generated in the communication unit 30 by the generator 31. When the generator 31 generates electricity, the wireless communication circuit 34 transmits a signal including the ID of the communication unit 30 to the human sensing system 90 via the wireless LAN access point apparatus 50. It is considered that when the door 80 is closing, the person who has opened the door 80 is in the vicinity of the door 80. When the human sensing system 90 receives the signal including the ID of the communication unit 30, the human sensing system 90 performs a human detection at an area, for example, associated with the door 80. The human sensing system 90 detect where the person is, when the door closer is operating, and controls the security device 73, the lighting device 74, the air conditioner 75 , and the like based on the detection result.

### [Operation Example]

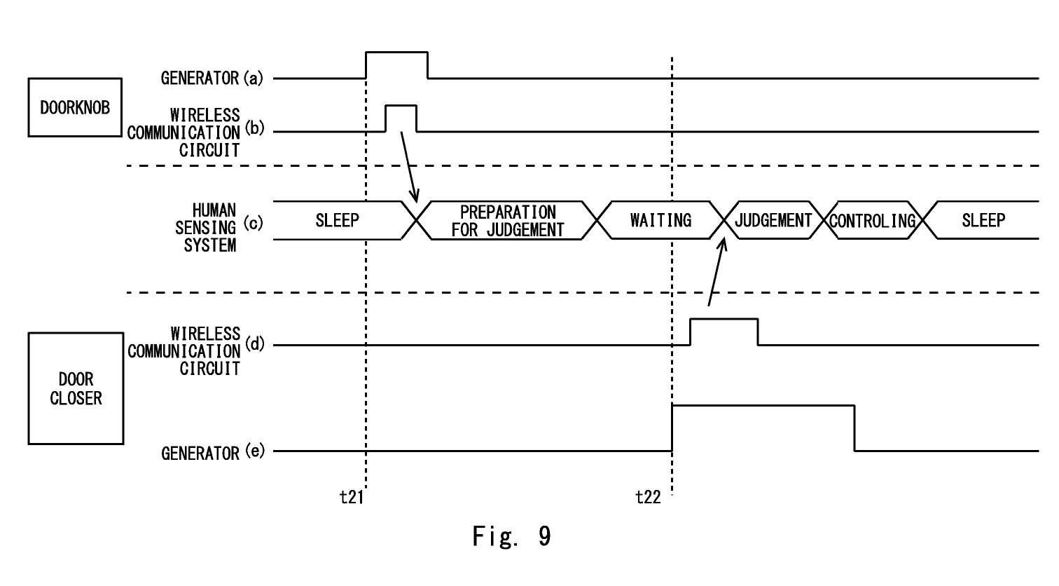

FIG. 9 is a timing chart showing operation circumstances of each unit in the signal processing system 10b. It is assumed that the human sensing system 90 is in a sleep state before it receives a signal from the communication unit 20. At time t21, when a user rotates a doorknob, the generator of the communication unit 20 disposed in the doorknob generates electricity (refer to (a) in FIG. 9). The wireless communication circuit 24 receives a power supply from the generator 21, and transmits a signal including a unique ID to the human sensing system 90 (refer to (b) in FIG. 9).

The human sensing system 90 initiates preparation (judgement preparation) for judgement of a human detection, when the signal is received from the wireless communication circuit 24 of the communication unit 20 (refer to (c) in FIG. 9). At that time, since the generator 21 generates electricity utilizing a rotary motion of the doorknob and a power generation period is short, the power supply to the wireless communication circuit 24 has been stopped before the judgement preparation is completed (refer to (a) and (b) in FIG. 9). The human sensing system 90 initiates the judgement preparation, for example, in the vicinity of the door to be opened/closed. The human sensing system 90 waits until a signal is transmitted from the wireless communication circuit 34 of the communication unit 30 after finishing the judgement preparation.

At time t22, when the door starts to close, the generator 31 of the communication unit 30 disposed in a door closer generates electricity (refer to (f) in FIG. 9). The wireless communication circuit 34 of the communication unit 30 receives a power supply from the generator 31, and transmits a signal including a unique ID to the human sensing system 90 (refer to (d) in FIG. 9). When the human sensing system 90 receives the signal from the wireless communication circuit 34, it terminates the waiting state and then performs a human detection (judgement) in a predetermined area. The human sensing system 90 controls the security device 73, the lighting device 74, the air conditioner 75, and the like based on the judgement result. The human sensing system 90 may transfer its state to a sleep state after performing the control. It should be noted that the external output circuit 35 may be omitted if it is not necessary to carry out a notification to the user.

### [Summary]

In the present embodiment, the human sensing system 90 initiates the judgement preparation upon receiving the signal from the communication unit 20, and after that, performs the judgement of human detection upon receiving the signal from the communication unit 30. By doing so, it is possible to operate the human sensing system 90 at a desired timing and quickly perform the human detection in a predetermined area, even if it takes time to activate the human sensing system 90. Further, in the present embodiment, it is not necessary for the human sensing system 90 to be activated all the time, and it is possible to realize the control of a lighting device and an air conditioner with lower power consumption.

### [Modified Example]

In each above described embodiment, an example in which a signal processing system comprises two communication units is mainly explained. However, a signal processing system may comprise a plurality of communication units, and the number of communication units is not limited to two. In addition, in the first embodiment, an example in which a transmission destination of signals of the communication unit 20 and the communication unit 30 is the external service server 70 connected to the internet 60 is explained. Further, in the second embodiment, an example in which the transmission destination of the signals is a device in a home such as the electric device 71 is explained. Furthermore, in the third embodiment, an example in which the transmission destination of the signals is the human sensing system 90 is explained. However, the present disclosure is not limited thereto. Various combinations can be considered as the transmission destination of the signals of the communication unit 20 and the communication unit 30.

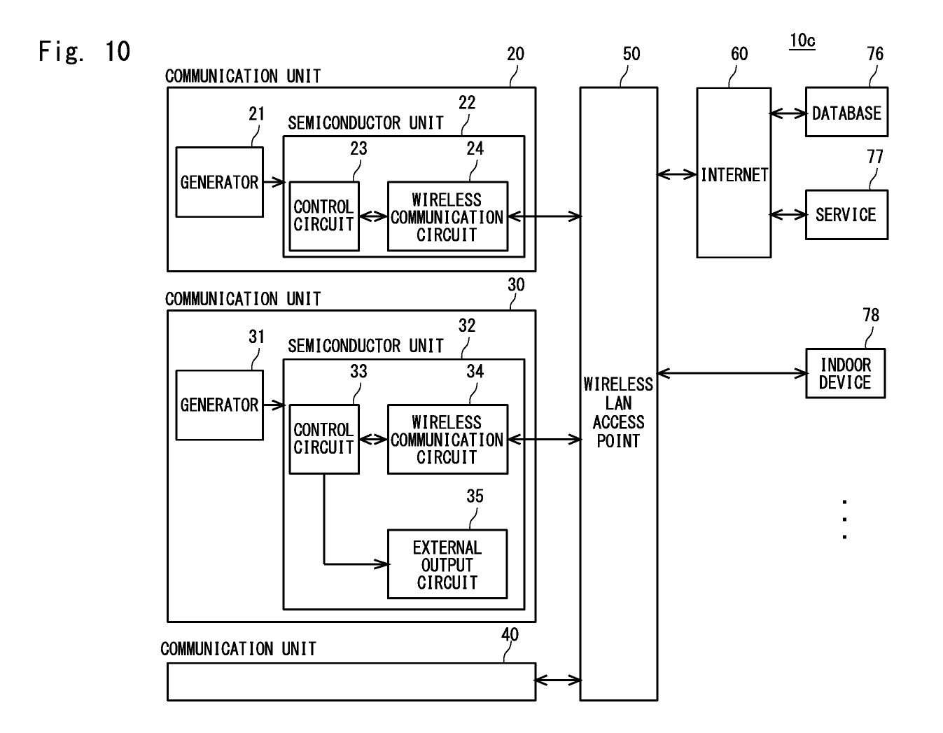

FIG. 10 shows a signal processing system 10c according to a modified example. A signal processing system 10c according to the modified example comprises a communication unit 40 in addition to the communication unit 20 and the communication unit 30. The communication unit 40 may have the same configuration as that of the communication unit 20 or the communication unit 30. A generator of the communication unit 40 generates electricity utilizing, for example, an action in the series of actions performed after actions which the generator 21 and the generator 31 respectively utilize to generate electricity. The signal processing system 10c may comprise many more communication units than three.

The communication unit 20, the communication unit 30, and the communication unit 40 can respectively transmit a signal to a database 76 and a service server 77, which are external devices or signal processing devices, through the wireless LAN access point apparatus 50 and the internet 60. Further, the communication unit 20, the communication unit 30, and the communication unit 40 can respectively transmit a signal to, for example, any indoor device 78 disposed in a home, which is an external device or a signal processing device, through the Wireless LAN access point apparatus 50. In this way, by transmitting the signal to a desired communication partner from each communication unit, it is possible to provide a desired service or the like, or it is possible to control a desired device.

It should be noted that, in each of the above-mentioned embodiments, although an example in which the communication unit 30 comprises the external output circuit 35 is explained, the present disclosure is not limited thereto. In the communication unit 30, the external output circuit 35 may be omitted. Further, although the communication unit 20 does not comprise an external output circuit in each of the above-mentioned embodiments, the present disclosure is not limited thereto. In each of the above-mentioned embodiments, the semiconductor unit of any communication unit can comprise an external output circuit. For example, the communication unit 20 may comprise an external output circuit.

In FIG. 5, an example in which the external service server 70 waits until it receives the signal from the communication unit 30, is shown. However, it is not necessary for the external service server 70 to wait until it receives the signal from the communication unit 30. For example, if the wireless communication circuit 24 of the communication unit 20 can receive the process execution result from the external service server 70 within a range of electric power and its duration generated by the generator 21 of the communication unit 20, the external service server 70 may transmit a signal indicating the process execution result to the communication unit 20 without waiting. For example, in a case where the maximum value of a response time is extremely low such in the case of a private network, the external service server 70 may transmit a signal indicating the process execution result to the communication unit 20. In this case, the control circuit 23 of the communication unit 20 may notify a user about the process execution result using an external output circuit disposed in the communication unit 20.

While the invention has been described in terms of several embodiments, those skilled in the art will recognize that the invention can be practiced with various modifications within the spirit and scope of the appended claims and the invention is not limited to the examples described above.

Two or more of the above described embodiments can be combined as desirable by one of ordinary skill in the art.

Further, the scope of the claims is not limited by the embodiments described above.

Furthermore, it is noted that, Applicant's intent is to encompass equivalents of all claim elements, even if amended later during prosecution.

What is claimed is:

1. A signal communication device, comprising:
a plurality of communication units respectively comprising a generator configured to generate electricity utilizing a predetermined action included in a series of actions, and a wireless communication unit configured to be operated by electric power supplied from the generator,
wherein the plurality of communication units include a first communication unit and a second communication unit,
the generator of the first communication unit generates electricity utilizing a first action included in the series of actions, and the wireless communication unit of the first communication unit transmits a first signal to an external device when the first action is done and the generator generates electricity,
the generator of the second communication unit generates electricity utilizing a second action which is performed after the first action in the series of actions, the wireless communication unit of the second communication unit transmits a second signal to the external device when the second action is done and the generator generates electricity.

2. The signal communication device according to claim 1, wherein the wireless communication unit of the second communication unit further receives at least one of a signal indicating a response to the first signal and a signal indicating a process execution result from the external device.

3. The signal communication device according to claim 2, wherein the wireless communication unit of the second communication unit receives the signal indicating the process execution result, and,
the second communication unit further comprises an external output circuit configured to carry out a notification according to the signal indicating the process execution result.

4. The signal communication device according to claim 1, wherein the first signal includes identification information unique to the first communication unit, and the second signal includes identification information unique to the second communication unit.

5. The signal communication device according to claim 1, wherein the first communication unit and the second communication unit are provided at a door, and,
the first action is rotation of a doorknob in opening and closing the door and the second action is an action of the door closing in opening and closing the door.

6. The signal communication device according to claim 5, wherein a door closer is provided at the door, and,
the generator of the first communication unit generates electricity utilizing rotating force applied to the doorknob, and the generator of the second communication unit generates electricity utilizing rotating force applied to a rotating shaft of the door closer.

7. The signal communication device according to claim 1, wherein generated electric power of the generator of the second communication unit is greater than generated electric power of the generator of the first communication unit.

8. A signal processing system, comprising:
a plurality of communication units respectively comprising a generator configured to generate electricity utilizing a predetermined action included in a series of actions, and a wireless communication unit configured to be operated by electricity supplied from the generator, and
a signal processing device configured to execute predetermined processes,
wherein the plurality of communication units include a first communication unit and a second communication unit,
the generator of the first communication unit generates electricity utilizing a first action included in the series of actions, and the wireless communication unit of the first communication unit transmits a first signal to the signal processing device when the first action is done and the generator generates electricity,
the generator of the second communication unit generates electricity utilizing a second action which is performed after the first action in the series of actions, the wireless communication unit of the second communication unit transmits a second signal to the signal processing device when the second action is done and the generator generates electricity.

9. The signal processing system according to claim 8, wherein the signal processing device initiates a first processing when the first signal is received, waits for the second signal to be received after executing the first process, and executes a second process when the second signal is received.

10. The signal processing system according to claim 8, further comprise a relaying device configured to relay communication between the plurality of communication unit and the signal processing device.

11. The signal processing system according to claim 10, wherein the wireless communication unit of each communication unit wirelessly communicates with the relaying device.

12. The signal processing system according to claim 9, wherein the second process includes a process to transmit at least one of a signal indicating a response to the first signal and a signal indicating a process execution result to the wireless communication unit of the second communication unit.

13. A signal communication method, comprising:
generating electricity utilizing a first action included in a series of actions;
transmitting a first signal to a signal processing device which executes predetermined processes, using the electricity generated by utilizing the first action;
generating electricity utilizing a second action which is performed after the first action in the series of actions; and
transmitting a second signal to the signal processing device using the electricity generated by utilizing the second action.
